(19) United States
(12) Patent Application Publication
(10) Pub. No.: US 2012/0309354 A1
(43) Pub. Date: Dec. 6, 2012

(54) SITUATION AWARE SECURITY SYSTEM AND METHOD FOR MOBILE DEVICES

(75) Inventor: Wenliang Du, Manlius, NY (US)

(73) Assignee: SYRACUSE UNIVERSITY, Syracuse, NY (US)

(21) Appl. No.: 13/298,865

(22) Filed: Nov. 17, 2011

Related U.S. Application Data
(60) Provisional application No. 61/493,540, filed on Jun. 6, 2011.

(51) Int. Cl. H04W 12/06

(52) U.S. Cl. 455/411; 455/410

(57) ABSTRACT

A mobile communication device can comprise a microprocessor, a memory, and one or more sensors, all coupled to a system bus. A sensor can be provided by a GPS receiving device, an accelerometer, an image sensor, a radio frequency transceiver, or a magnetic card reading device. The mobile communication device can be configured, responsive to receiving sensor data from one or more sensors, to select a corresponding security alert level. The mobile communication device can be further configured to perform at least one security-related action corresponding to the selected security alert level.

### CROSS REFERENCE TO RELATED APPLICATIONS

The present PCT application claims the priority of U.S. Provisional Application No. 61/493,540, filed Jun. 6, 2011, entitled “Situation Aware Security System and Method for Mobile Devices,” which is incorporated herein by reference in its entirety.

### STATEMENT REGARDING FEDERALLY SPONSORED RESEARCH OR DEVELOPMENT

This invention was made with government support under Contract No. 1017771 awarded by the National Science Foundation (NSF). The government has certain rights in the invention.

### FIELD OF THE INVENTION

The present invention relates to mobile device security and, more particularly, to a system and method for providing situational based security.

### BACKGROUND OF THE INVENTION

Mobile devices, such as smartphones, store a lot of personal information, as well as passwords that allow their owners to log into email servers, web accounts, wifi networks, etc. If a device is stolen or lost, not only will the information on the device be compromised, so will any information on the remote servers. Therefore, it is very important to protect the personal information in a phone if it is lost.

### SUMMARY OF THE INVENTION

In one embodiment, there is provided a mobile communication device comprising a microprocessor, a memory, and one or more sensors, all coupled to a system bus. A sensor can be provided by a GPS receiving device, an accelerometer, an image sensor, a radio frequency transceiver, or a magnetic card reading device. The mobile communication device can be configured, responsive to receiving sensor data from one or more sensors, to select a corresponding security alert level. The mobile communication device can be further configured to perform at least one security-related action corresponding to the selected security alert level.

In another embodiment, there is provided a mobile communication device comprising a microprocessor, a memory, and one or more sensors, all coupled to a system bus. A sensor can be provided by a GPS receiving device, an accelerometer, an image sensor, a radio frequency transceiver, or a magnetic card reading device. The mobile communication device can be configured, responsive to receiving sensor data from one or more sensors, to select a device authentication level based on the sensor data.

In another embodiment, there is provided a mobile communication device comprising a microprocessor, a memory, and a radio frequency transceiver, all coupled to a system bus. The mobile communication device can be configured, responsive to successfully validating a data item received from the radio frequency transceiver, to unlock the mobile communication device without requiring a user-entered password. The mobile communication device can be further configured, responsive to failing to successfully validate a data item received from the a radio frequency transceiver, to request a user-entered password in order to unlock the mobile communication device.

In another embodiment, there is provided a mobile communication device comprising a microprocessor, a memory, and a radio frequency transceiver, all coupled to a system bus. The mobile communication device can be configured to encrypt a first data item stored in the memory using an encryption key derived from a second data item received from an RFID tag, NFC tag, or a Bluetooth device by the radio frequency transceiver. The mobile communication device can be further configured, responsive to receiving a request from an application executed by the mobile communication device, to decrypt the first data item yielding a decrypted data item, and to provide the decrypted data item to the application

In another embodiment, there is provided a mobile communication device comprising a microprocessor, a memory, and a radio frequency transceiver, all coupled to a system bus. The mobile communication device can be configured to poll RF targets (including, e.g., RFID tags, NFC targets, and Bluetooth devices) using the radio frequency transceiver. The mobile communication device can be further configured, responsive to successfully validating a data item received by the radio frequency transceiver, to unlock the mobile communication device, unlock an application executed by the mobile communication device, or unlock a function of an application executed by the mobile communication device

In another embodiment, there is provided a mobile communication device comprising a microprocessor, a memory, and one or more sensors, all coupled to a system bus. A sensor can be provided by a GPS receiving device, an accelerometer, an image sensor, a radio frequency transceiver, or a magnetic card reading device. The mobile communication device can be configured to validate a sensor data pattern, responsive to receiving sensor data from one or more sensors including the radio frequency transceiver. The mobile communication device can be further configured, responsive to successfully validating a sensor data pattern, to perform at least one action corresponding to the sensor data pattern.

### BRIEF DESCRIPTION OF THE DRAWINGS

The features described herein can be better understood with reference to the drawings described below. The drawings are not necessarily to scale, emphasis instead generally being placed upon illustrating the principles of the preferred embodiments. In the drawings, like numerals are used to indicate like parts throughout the various views.

FIG. 1 schematically illustrates a component diagram of a mobile communication device;

FIG. 2 schematically illustrates one embodiment of security alert level definitions;

FIG. 3 schematically illustrates one embodiment of a table mapping security alert levels to alert-related actions;

FIG. 4 illustrates a functional diagram of a mobile communication device;

FIG. 5 schematically illustrates one embodiment of a process comprising interactions of a key management module with applications executed by a mobile communication device;

FIG. 6 schematically illustrates one embodiment of a process comprising interactions of an access control management module with applications executed by a mobile communication device;

FIG. 7 schematically illustrates one embodiment of a process of mobile communication device validating a data pattern and invoking an application corresponding to the data pattern;

FIG. 8 schematically illustrates one embodiment of a mobile device having a framework for providing Situation-Aware Security Enhancement. FIG. 8 is reproduced from FIG. 1 of U.S. Provisional Patent Application No. 61/493,540.

### DETAILED DESCRIPTION OF THE INVENTION

In one embodiment, there is provided a mobile communication device comprising one or more wireless communication interfaces, e.g., a Bluetooth communication interface, an IEEE802.11-compliant communication interface, a GSM communication interface, or a CDMA communication interface. The mobile communication device can further comprise one or more sensors, e.g., a GPS receiving device, an accelerometer, an image sensor, a radio frequency transceiver, or a magnetic card reading device. The mobile communication device can be capable of executing one or more application programs (e.g., an Internet browser, an e-mail client, a social network client, an Internet shopping application, or an Internet banking application). One or more application programs can store application data (e.g., a contact list, a browsing history, or browser cookies) in the volatile and/or non-volatile memory of the mobile communication device.

In one embodiment, mobile communication device 10 can be provided by a smartphone. In another embodiment, mobile communication device 10 can be provided by a personal digital assistant (PDA). In a yet another embodiment, mobile communication device 10 can be provided by a portable computer. In a yet another embodiment, mobile communication device 10 can be provided by a portable data terminal.

The mobile communication device can be configured, responsive to receiving sensor data from one or more sensors, to select a security alert level based on the sensor data. The mobile communication device can be further configured to perform at least one security-related action corresponding to the selected security alert level, e.g., erasing application data, erasing application passwords, encrypting application data, or locking the mobile communication device.

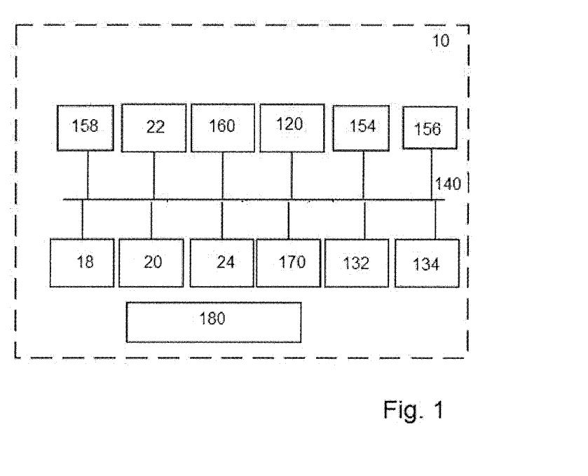

FIG. 1 illustrates a functional diagram of a mobile communication device 10 having microprocessor 120 and memory 130 both coupled to system bus 140. Memory 130 can be provided by a volatile memory 132 (e.g., random access memory (RAM)) and/or non-volatile memory 134 (e.g., electrically-programmable read-only memory (EPROM)). Mobile communication device 10 can further comprise one or more wireless communication interfaces, e.g., a Bluetooth communication interface 22, an IEEE802.11-compliant communication interface 154, a GSM communication interface 156, and/or a CDMA communication interface 158. Mobile communication device 10 can further comprise one or more sensors, including a global positioning system (GPS) receiving device 18, a radio frequency transceiver 20, an imaging device 24, an accelerometer or motion sensor 30, and/or a magnetic card reading device 32. In one embodiment, radio frequency transceiver 20 can be provided by an NFC reading device. In another embodiment, radio frequency transceiver 20 can be provided by an RFID reading device. In a yet another embodiment, radio frequency transceiver 20 can be provided by a Bluetooth communication device. Mobile communication device 10 can further comprise display 160, keyboard 170, and power supply 180.

As noted herein supra, mobile communication device 10 can be capable of executing one or more application programs (e.g., an Internet browser, an e-mail client, an Internet shopping application, or an Internet banking application) configured to communicate with external servers over one or more wireless communication interfaces. One or more application programs can be configured to store application-specific data (e.g., an e-mail contact list, a browsing history, or browser cookies) in the volatile 132 and/or non-volatile 134 memory of mobile communication device 10.

Mobile communication device 10 can be configured, responsive to receiving sensor data from one or more sensors, to select a security alert level based on the sensor data. In one embodiment, two or more alert levels can be sequentially enumerated from an alert level indicating a low security risk to an alert level indicating a high security risk. An alert level can be defined based on one or more conditions, including, e.g., a “known” Bluetooth device, RFID tag, or NFC tag having been detected, a “known” LAN having been detected, a pre-defined geographical area having been detected, and a pre-defined movement pattern having been detected. A “known” Bluetooth device is understood to mean a Bluetooth device previously registered with mobile communication device 10. A “known” RFID tag or NFC tag is understood to mean an RFID tag or NFC tag previously registered with mobile communication device 10. An RFID tag or NFC tag can be registered with mobile communication device 10, for example, by storing in a memory of mobile communication device 10 a hash function of the RFID tag identifier or NFC tag identifier, or of a value stored in the RFID tag's user memory or NFC tag's memory. A “known” LAN is understood to mean a LAN previously registered with mobile communication device 10 as a “safe” network. An RFID tag or NFC tag can be registered with mobile communication device 10, for example, by storing in a memory of mobile communication device 10 a hash function of the SSID of a Wi-Fi access point.

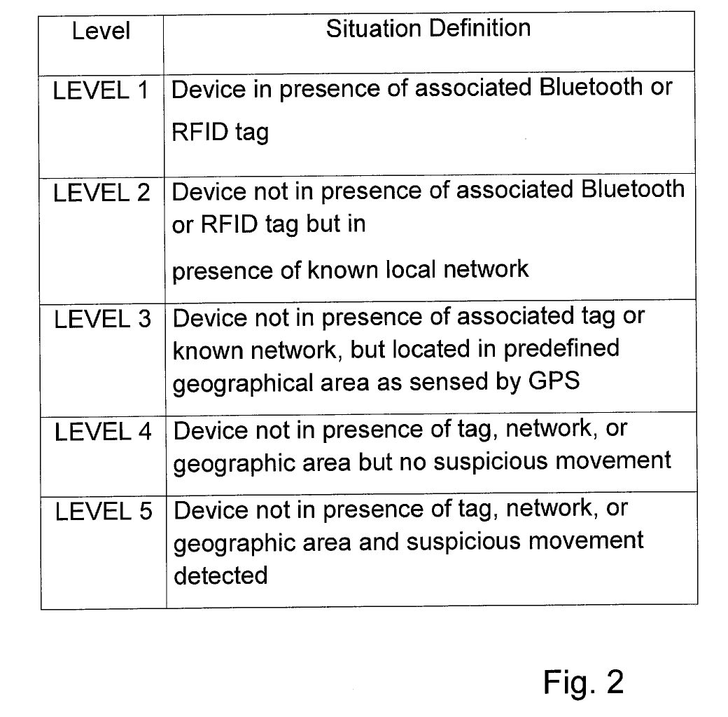

One embodiment of security alert level definitions is schematically shown in FIG. 2. For example, a low risk level can be assumed if mobile communication device 10 detects a presence of a known Bluetooth device, known RFID tag, and/or known NFC tag. In a further aspect, Bluetooth, RFID or NFC device used to indicate a low risk level can be worn by the device user on a key chain or in a wallet. The RFID tag or NFC tag can be attached to a ring worn be the device user, so when users hold the phone, the tag can always be detected. The RFID tag or NFC tag can also be placed into pockets of device user's clothes or woven into device user's clothes.

In another example, a higher risk level can be assumed if mobile communication device 10 fails to detect a presence of a known Bluetooth device, known RFID tag, and/or known NFC tag, but detects a presence of a known local area network (e.g., a Wi-Fi network). In a yet another example, a higher risk level can be assumed if mobile communication device 10 fails to detect a presence of both known Bluetooth device, known RFID tag, and/or known NFC tag, and also fails to detect a presence of a known local area network (e.g., a Wi-Fi network), but is physically located within a pre-defined geographical area (e.g., device's user home or office). In a yet another example, a higher risk level can be assumed if mobile communication device 10 fails to detect a presence of both known Bluetooth device, known RFID tag, and/or known NFC tag, and also fails to detect a presence of a known local area network (e.g., a Wi-Fi network), and is not physically located within a pre-defined geographical area. In a yet another example, a highest risk level can be assumed if mobile communication device 10 fails to detect a presence of both known Bluetooth device, known RFID tag, and/or known NFC tag, and also fails to detect a presence of a known local area network (e.g., a Wi-Fi network), is not physically located within a pre-defined geographical area, and device movement is detected.

Mobile communication device 10 can be further configured to perform at least one security-related action corresponding to the selected security alert level, e.g., erasing application data, erasing application passwords, encrypting application data, or locking the mobile communication device. In a further aspect, a particular security alert level can be signaled to one or more applications, so that the applications would be able to implement pre-determined security alert-related actions. In one embodiment, a security alert-related action can be, e.g., erasing a browser history, browser cache, and/or browser cookies. In another embodiment, a security alert-related action can be, e.g., erasing application data and/or stored application credentials (for example, a stored application password). In a yet another embodiment, a security alert-related action can be, e.g., encrypting stored application data. In a yet another embodiment, a security alert-related action can be, e.g., encrypting or erasing a contact list. In a yet another embodiment, a security alert-related action can be, e.g., locking mobile communication device 10 (for example, mobile communication device 10 can be locked in a mode un-lockable by a user-entered password).

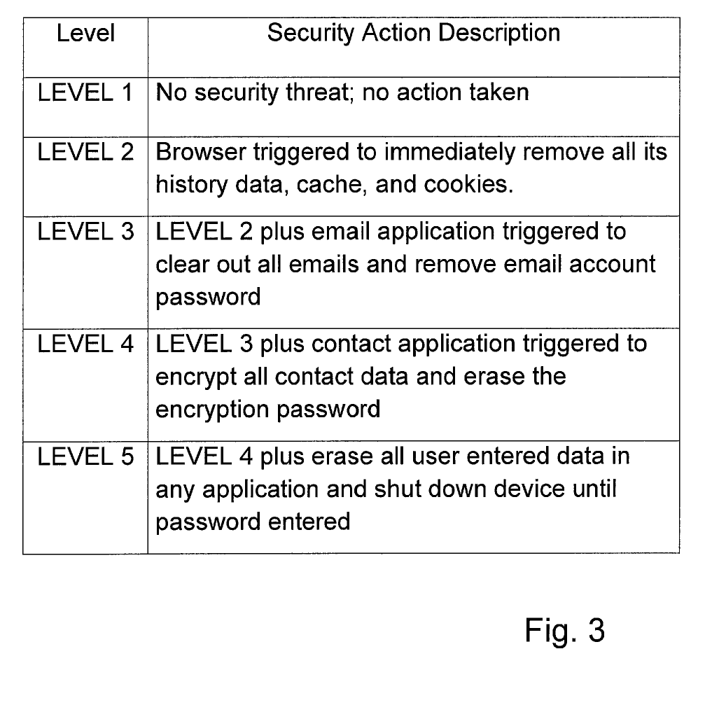

FIG. 3 illustrates one embodiment of a table mapping security alert levels to alert-related actions. The security alert-related actions can be designed to protect the security of the information stored on or accessed by mobile communication device 10 in a situation when mobile communication device 10 is perceived to be at a risk level corresponding to the sensor data received from one or more sensors. For example, in a situation when mobile communication device 10 is not in presence of a known RFID tag, NFC tag, Wi-Fi network, and is outside of a pre-defined geographical area, the device can assumed to be lost or stolen, and thus at risk of being accessed by an unauthorized user. Hence, erasing application credentials and other information stored in the memory of mobile communication device 10 can be an adequate security alert-related action. When a perceived risk level is lower, less dramatic response can be adequate, for example, application data stored in the memory of mobile communication device 10 can be encrypted rather than erased. In one embodiment, application data stored in the memory of mobile communication device 10 can be encrypted using an asymmetric encryption key, so that the key needed for the decryption of the encrypted data would not have to be stored in the memory of mobile communication device 10.

In another embodiment, mobile communication device 10 can be configured, responsive to receiving sensor data from one or more sensors, to select a device authentication level based on the sensor data. In one embodiment, possible device authentication levels can comprise: no user authentication required to use the device; user-entered password is required to unlock the device; a presence of a known RFID tag or NFC tag is required to unlock the device.

In another embodiment, mobile communication device 10 can be configured, responsive to successfully validating a data item received from the radio frequency transceiver 20, to unlock mobile communication device 10 without requiring a user-entered password. A data item received from the radio frequency transceiver 20 can be validated, e.g., by calculating a hash function of the data item and comparing the resulting value with a value stored in a memory of the mobile communication device 10. The data item can be, e.g., RFID tag identifier, NFC tag identifier, a value stored in the RFID tag's user memory, or a value stored in the NFC tag's memory.

Mobile communication device can be further configured, responsive to failing to successfully validate a data item received from the radio frequency transceiver 20, to request a user-entered password in order to unlock mobile communication device 10.

For example, mobile communication device 10 can be configured to transition into a locked state upon expiration of a pre-defined timeout since last user interaction. In one embodiment, mobile communication device 10 can be unlocked by a password entered by the device user via a keyboard or a touch-screen. In one embodiment, mobile communication device 10 can be configured to transition into an unlocked state responsive to detecting a presence of a “known” RFID tag or NFC tag previously registered with the device. Thus, a user would need simply to pass device 10 by a known RFID tag or NFC tag to unlock the device, rather than having to enter a predetermined password. This embodiment would be particularly useful in situations where a user does not have a free hand for typing, or is using the device in a location where user entry is not permitted, such as in a vehicle travelling in a state that prohibits use of device 10 while driving. In these instances, a user could pass device 10 by a NFC tag located in the vehicle to unlock device 10 and then use voice commands to place a telephone call, thereby avoiding the need for manual entry of any information entirely and avoiding a violation of state law or unnecessarily distracting the user from driving activities.

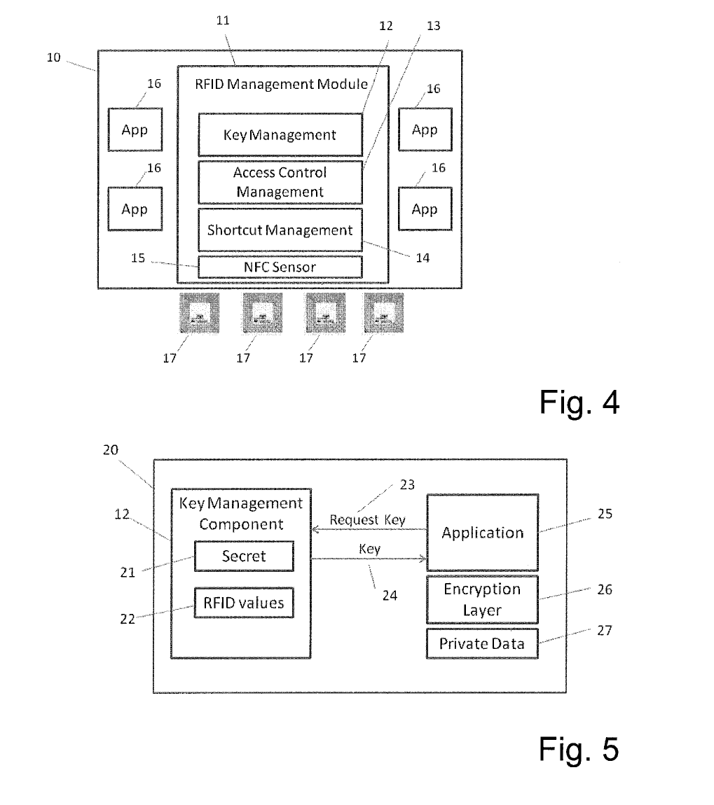

In one embodiment, schematically shown in FIG. 4, mobile communication device 10 can comprise an RFID/NFC management module 11. In a further aspect, RFID/NFC management module 11 can include three modules: key management module 129, access control management module 13, and shortcut management module 149. These three modules can be mutually independent, so they can be individually installed on device mobile communication device 10. These three modules communicate with the applications 169 executed by mobile communication device 10 to help achieve security and convenience. In one embodiment, at least one of the modules 11, 129, 13, and 149 can be implemented as a software module. In another embodiment, each of the modules 11, 129, 13, and 149 can be implemented as a hardware module.

As noted herein supra, mobile communication device 10 can comprise radio frequency transceiver 20 which in one embodiment can be provided by an NFC reading device. The NFC reading device can be configured to poll NFC targets which can be present in the vicinity of mobile communication device 10. In another embodiment, the radio frequency transceiver 20 can be provided by an RFID reading device. The RFID reading device can be configured to poll RFID targets which can be present in the RFID communication range of the mobile communication device 10.

In one embodiment, mobile communication device 10 can be configured to encrypt a data item stored in a memory (e.g., an application credential, an access token, or an application-specific data item, a user's personal data item, etc.) using an encryption key derived from another data item received from an NFC tag by the NFC reading device. Mobile communication device 10 can be further configured, responsive to receiving a request from an application executed by the mobile communication device, to decrypt the application data item, and to provide the decrypted data item to the requesting application.

Many applications running on today's mobile devices deal with users' online accounts. To access those accounts, users need to type in their credentials (user identifiers and passwords). To reduce the typing effort by the users, the credentials are often cached by mobile devices. Moreover, once a user has logged in, a server can return to the application a re-usable access token (e.g., a cookie in case of a web application). The access token can also be cached by the mobile device to be re-used in subsequent transactions without requiring the user to re-type a user identifier and/or a password. In addition, while using some applications, users may also type in other types of personal data, such as mailing address, credit card data, date of birth, etc. For convenience reasons, these types of information may also be cached by mobile devices. In many cases, this cached information does not expire for a long period time, and hence can be accessed by an authorized user of the mobile communication device (e.g., if the device is lost or stolen). The user's private data, including application credentials, access tokens, and personal data, the data can be encrypted. However, it is unsafe to save the encryption key permanently on the device, because once the device is stolen, the key can be discovered. Furthermore, it is not convenient to ask the user to type the key into the system frequently.

FIG. 5 illustrates one embodiment of a process 209 comprising interactions of a key management module 129 and an application 25 that uses key management module 129 for managing encryption keys. The key management module 129 can contain a secret 21 set by a user and an RFID data item (or NFC data item) 229 obtained from scanning a user-provided RFID tag (or NFC tag). Using secret 21 and data item 229, key management module 129 can generate an encryption key 249 for application 25 by feeding the secret and the RFID data item (or NFC data item) to a secure one-way hash function described by:

Key=hash(Secret,RFID,R),

wherein R is a unique number associated with each application, and
hash is a secure one-way hash function, such as SHA-256.

In a further aspect, mobile communication device 10 can be configured to periodically ascertain the presence of the RFID tag or NFC tag from which the RFID data item (or NFC data item) used to generate the encryption key was obtained. Mobile communication device 10 can be further configured to delete the RFID data item (or NFC data item) from the device memory upon expiration of a pre-defined time interval elapsed since mobile communication device's failure to detect the presence of the RFID tag or NFC tag (e.g., when the RFID tag (or NFC tag) and mobile communication device are physically removed from each other). Hence, even if mobile communication device 10 is accessed by an unauthorized user (e.g., when mobile communication device 10 is lost or stolen), the unauthorized user could not reconstruct the encryption keys for the applications running on mobile communication device 10, unless the unauthorized user also got possession of the RFID tag (or NFC tag) from which the data item used to generate the encryption key can be obtained.

In a situation when an unauthorized user can be assumed to have possession of both mobile communication device 10 and the RFID tag or NFC tag from which the data item used to generate the encryption key can be obtained, the authorized user of mobile communication device 10 can remotely send a command to the device to erase secret 21 from the device memory. Hence, even if both mobile communication device 10 and the RFID tag or NFC tag are in possession of an unauthorized user, the unauthorized user could not reconstruct the encryption keys for the applications running on mobile communication device 10 once secret 21 has been removed from the device.

In a further aspect, application 25 that intends to use RFID data or NFC data as encryption keys can send a get-key request 23 to key management module 129. Upon receiving the request, management module 129 can ascertain a presence of an RFID target or NFC target within the RFID communication range of mobile communication device 10, retrieve an RFID data item (or NFC data item), generate an encryption key 249 using the above described process and return the generated encryption key to the requesting application 25. The application 25 can then use the received key 249 to encrypt the user's private data 27 using the encryption layer 269.

In another embodiment, application 25 that intends to use encryption keys can send a get-key request 23 to key management module 12. Upon receiving the request, management module 129 can ascertain a presence of a Bluetooth device within the communication range of mobile communication device 10. In a further aspect, management module 129 can request a user to push a button on the Bluetooth device to activate transmission by the Bluetooth device.

Management module 129 can retrieve a data item from the Bluetooth device, generate an encryption key 249 based on the retrieved data item using the above described process and return the generated encryption key to the requesting application 25. The application 25 can then use the received key 249 to encrypt the user's private data 27 using the encryption layer 269.

In another embodiment, mobile communication device 10 can be configured, responsive to successfully validating a data item received from the radio frequency transceiver 20, to unlock the mobile communication device, unlock an application executed by the mobile communication device, or unlock a function of an application executed by the mobile communication device.

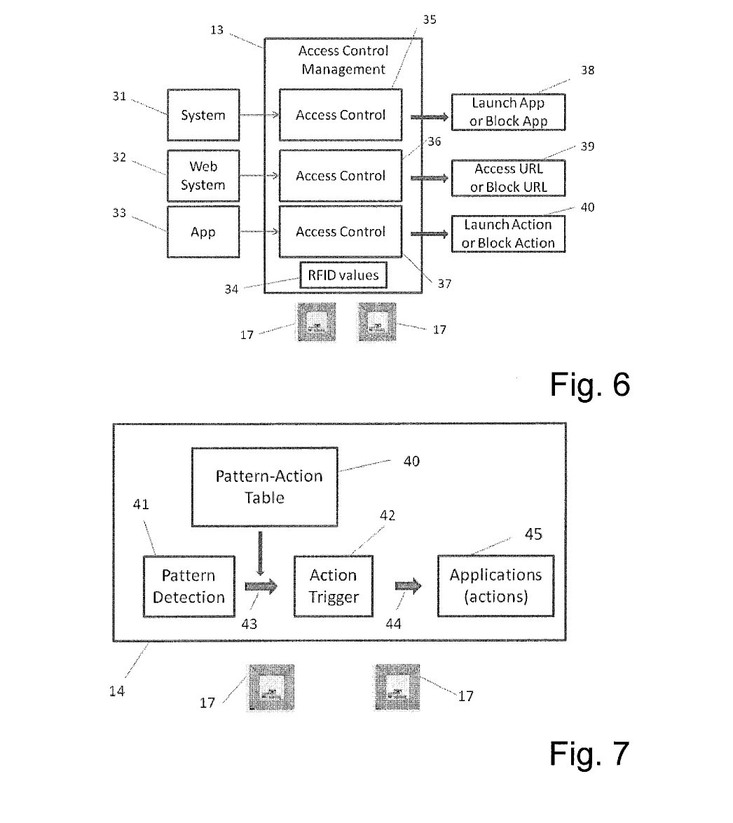

FIG. 6 illustrates one embodiment of a process 122 comprising interactions of an access control management module 13 with applications 25. The user of mobile computing device 10 can scan an RFID tag or NFC tag to unlock device 10, an application being executed by device 10, an operating system function that can be used of one or more applications being executed by device 10, or a function of an application being executed by device 10.

As noted herein supra, in one embodiment, mobile communication device 10 can be configured to transition into a locked state upon expiration of a pre-defined timeout since last user interaction. In one embodiment, mobile communication device 10 can be unlocked by a password entered by the device user via a keyboard or a touch-screen. In one embodiment, mobile communication device 10 can be configured to transition into an unlocked state responsive to detecting a presence of a “known” RFID tag or a “known” NFC tag previously registered with the device.

Mobile computing device 10 can comprise application access control module 35 which can control access to one or more applications that can be executed by mobile computing device 10. In one embodiment, the user of mobile computing device 10 can set an access control policy comprising one or more of access control rules. An access control rule can include an identifier of an application and a data item validating rule. In a further aspect, a data item validating rule can be provided by a hash function and a stored validating value. In operation, responsive to receiving a request to launch a particular application, mobile computing device can retrieve the access control rule corresponding to the application. Then, responsive to detecting a presence of an RFID target (or NFC target), mobile computing device 10 can request the RFID tag identifier (or NFC tag identifier) or a particular data item from the RFID target (or NFC target). Finally, mobile computing device 10 can apply the data item validating rule of the corresponding access control rule by calculating the hash function of the data item retrieved from the RFID tag or NFC tag and compare the result to the validating value stored in the validating rule. Should the comparison fails, mobile computing device can deny access to the application. The above described functionality can be useful, e.g., when a particular application accesses a particularly sensitive information which warrants additional access control measures, or when an owner of mobile computing device 10 wishes to restrict the ability of a user of the device to launch one or more applications. For example, a parent can use the above described functionality restrict the ability of his or her child to launch gaming applications during school hours. In another example, for a company-owned smartphone, the company my want to restrict the ability of the smartphone user other than an information technology support professional to execute some applications.

In one embodiment, an access control rule can further include an identifier of an application function, thus providing more granular access control to one or more functions of an application that can be executed by mobile computing device 10. Function-level access can be controlled by access control module 369. For example, an online banking application can include one or more functions (e.g., funds transfer) which would not execute unless a particular RFID tag or NFC tag is present and has been successfully validated.

Access control module 37 can control access to one or more operating system functions that can be used of one or more applications being executed by device 10. For example, an access control policy of mobile computing device 10 can require that a particular RFID tag or NFC tag be present and successfully validated in order to invoke a network access module that can be used by several applications running on mobile computing device 10.

In one embodiment, at least one of the modules 35, 369 and 37 can be implemented as a software module. In another embodiment, each of the modules 35, 369 and 37 can be implemented as a hardware module.

In another embodiment, mobile communication device 10 can be configured to validate a sensor data pattern and, responsive to successfully validating the sensor data pattern, to perform an action corresponding to the sensor data pattern.

FIG. 7 illustrates a process of mobile communication device 10 validating a data pattern and invoking an application corresponding to the data pattern. In one embodiment, a user of mobile communication device 10 can invoke an application by “touching” an NFC tag 17 with device 10. “Touching” an NFC tag with device 10 means herein “bringing device 10 within the NFC reading range of NFC tag 17, without necessarily literally touching the tag by device 10. The above described method of invoking an application can be particularly advantageous, for example, for invoking frequently used applications, or in a situation when typing on the keyboard of the device 10 could not be performed (e.g., if the user of device 10 is driving a car).

Mobile device 10 can be configured to validate a sensor data pattern including “touching” one or more previously registered NFC tags in a pre-defined sequence. For example, a user of mobile device 10 can touch one of the NFC tags 17 or make a series of touch of the tags. Thus, even with a small number of NFC tags, the user can create many different patterns, each representing a command.

In a further aspect, NFC tag data can be combined with other sensor data to provide even more patterns. For example, an accelerometer can detect device 10 being shaken, thus allowing for patterns like “NFC tag A, NFC tag B, and shake the device”. The GPS reading device data can allow for situation aware patterns, e.g., to distinguish between user's home, user's office, and other (unknown) geographical areas.

Referring again to FIG. 7, a pattern detection module 51 can identify the sensor data patterns. An identified data pattern can be fed to action trigger module 52, which can match the identified pattern with a pre-set action in the pattern-action table 50. If a match is found, the action trigger module 52 will trigger the action corresponding to the pattern.

In one embodiment, at least one of the modules 51 and 52 can be implemented as a software module. In another embodiment, each of the modules 51 and 52 can be implemented as a hardware module.

An excerpt is presented herein from U.S. Provisional Patent Application No. 61/493,540 with minor formatting changes and with reference numerals changed to avoid duplication.

[Excerpt taken from U.S. Provisional Patent Application No. 61/493,540]

The present invention provides a framework for a Situation-Aware Security Enhancement (SASE) that enables mobile devices, such as smartphones, to protect information contained thereon. The key component of the framework is the situation-sensing engine, which monitors a number of sensors. The values of the sensors are compared with predefined or user configured security policies. If any triggering condition is matched, a corresponding alert will be broadcasted to all applications. For example, one policy in the framework may be that if the device cannot find a companion Bluetooth device, the alert level will be raised. A change in alert level may be configured to result in certain steps being taken to protect information on the device, such as clearing of a cache. The SASE framework of the present invention will allow application developers to use the framework to enhance their applications and improve information security if a device is lost or stolen.

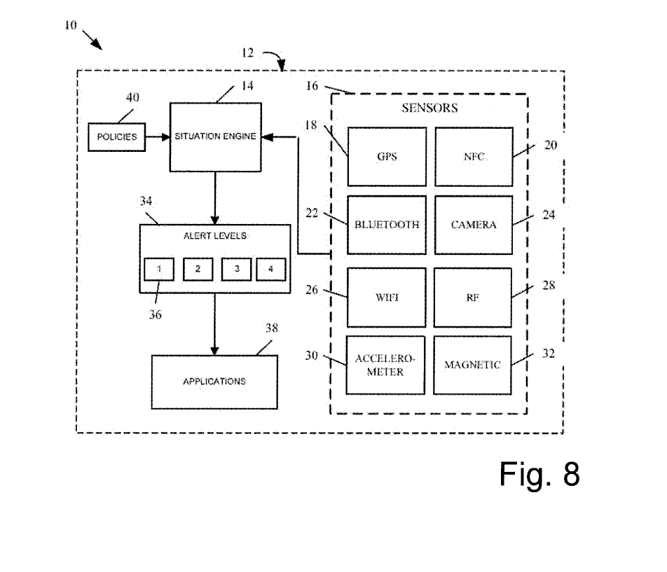

Referring now to the drawings, wherein like reference numerals refer to like parts throughout, there is seen in FIG. 8 a mobile device 10 having a framework 12 therein for providing a Situation-Aware Security Enhancement (SASE) according to the present invention. Framework 12 includes a situation engine 14 that is responsible for detecting and determining the situation of mobile device 10. Engine 14 may be interconnected to one of more of the numerous sensors 16 provided on mobile device 10, such as a global positioning system (GPS) 18, a near field computing (NFC) sensor 20, a Bluetooth interface 22, a camera 24, a WiFi transceiver 26, an RF transceiver 28, an accelerometer or motion sensor 30, a magnetic sensor 32, etc.

As further seen in FIG. 8, engine 14 may be programmed to evaluate the information provided by one or more of the sensors 16 and select from a series of predetermined alert levels 34 a particular alert level 36 based on the information provided by the sensors. Alert level 34 can comprise a simple hierarchy of steps, such as Level 1, Level 2, Level 3, etc., or a more sophistical logical architecture. The particular alert level 36 may then be broadcast to one or more applications 38 on the device 10 so that predetermined security measures may be implemented by those applications 38. As further seen in FIG. 8, the policies 40 governing alert triggering are interconnected to engine 14 and may be preconfigured or user configurable.

As seen in Table 1 below, the important characteristic of the alert levels 36 is that each level is associated with a different or heightened security risk and consequently triggers the execution of different steps to address the security risk.

TABLE 1

| Level | Security Action Description |
|---|---|
| LEVEL 1 | No security threat; no action taken |
| LEVEL 2 | Browser triggered to immediately remove all its history data, |
| | cache, and cookies. |
| LEVEL 3 | LEVEL 2 plus email application triggered to clear out all |
| | emails and remove email account password |
| LEVEL 4 | LEVEL 3 plus contact application triggered to encrypt all |
| | contact data and erase the encryption password |
| LEVEL 5 | LEVEL 4 plus erase all user entered data in any application |
| | and shut down device until password entered |

For example, at a particular risk level, the browser may be triggered to immediately remove all its history data, cache, and cookies. Therefore, even if the device is stolen, all web-account credentials will have been removed, thereby protecting the privacy of the device owner's online accounts, such as social networking and online banking accounts. At the same or a different risk level, the email application may additionally be triggered to clear out all the emails on the device as well as removing the password of the email account. Similarly, the contact application can be triggered to encrypt all contact data and erase the encryption password if the alert level reaches a particular value (in the event of a false alarm, the device owner can provide the password to decrypt the contact data). Framework 12 may additionally require a hierarchy of increasingly advanced user steps depending on the alert level determined by engine 14. For example, when the alert level is determined to be low, the owner will not have to take extreme authentication measures and could simply provide the standard login. If the alert level is determined to be high, however, a stronger authentication will be required, such as the entry of a separate password.

As seen in Table 2 below, policies 40 may be developed for use by engine 14 based on any combination of situational information provided by sensors 16.

TABLE 2

| Level | Situation Definition |
|---|---|
| LEVEL 1 | Device in presence of associated Bluetooth or RFID tag |
| LEVEL 2 | Device not in presence of associated Bluetooth or RFID |
| | tag but in presence of known local network |
| LEVEL 3 | Device not in presence of associated tag or known network, |
| | but located in predefined geographical area as sensed by GPS |
| LEVEL 4 | Device not in presence of tag, network, or geographic area |
| | but no suspicious movement |
| LEVEL 5 | Device not in presence of tag, network, or geographic area |
| | and suspicious movement detected |

For example, a companion Bluetooth device that periodically communicates with device 10 via Bluetooth interface 22, indicating that it is still nearby device 10, may be used to provide situation security. A user can put the Bluetooth device on a key chain or in a wallet. If the device is removed from proximity to the Bluetooth device, engine 14 will detect the loss of signal, make a determination as to the appropriate alert level, and trigger the taking of any appropriate steps by other application based on that alert level. Similarly, the NFC sensor 20 can sense whether a companion NFC tag (e.g., an RFID tag) is present when the device is on. If the tag is detected, the alert level can be reduced, triggering weaker authentication for convenience. The RFID tag can be attached to rings, so when users hold the phone, the tag can always be detected. The tag can also be placed in other safe places, such as pockets or woven into clothes. Engine 14 may also be used to make security determination based on whether the device is in proximity to known wireless networks, such as those in a home, office, or campus and take appropriate action if those networks are lost.

It should be recognized by those of skill in the art that engine 14 may also be used to perform other tasks in additional to directing security measures to be taken by applications 38 on device 14. For example, engine 14 may be used to determine the proximity of device 10 to an companion NFC tag for the purposes of unlocking the screen of device 10. In this embodiment, a user need simply pass device 10 by NFC tag to allow use of the device, rather than having to enter a predetermined password into the keyboard. This embodiment would be particularly useful in situations where a user does not have a free hand for typing, or is using the device in a location where user entry is not permitted, such as in a vehicle travelling in a state that prohibits use of device 10 while driving. In these instances, a user could pass device 10 by a NFC tag located in the vehicle to unlock device 10 and then use voice commands to place a telephone call, thereby avoiding the need for manual entry of any information entirely and avoiding a violation of state law or unnecessarily distracting the user from driving activities.

[End of Excerpt taken from U.S. Provisional Patent Application No. 61/493,540]

A small sample of systems methods and apparatus that are described herein is as follows:

A1. A mobile communication device comprising:

a microprocessor coupled to a system bus;

a memory coupled to said system bus;

one or more sensors coupled to said system bus, said one or more sensors selected from the group consisting of: a GPS receiving device, an accelerometer, an image sensor, a radio frequency transceiver, a magnetic card reading device;

wherein said mobile communication device is configured, responsive to receiving sensor data from said one or more sensors, to select a security alert level based on said sensor data; and

wherein said mobile communication device is further configured to perform at least one security-related action corresponding to said security alert level.

A2. The mobile communication device of A1, wherein said radio frequency transceiver is provided by one of: an RFID reading device, an NFC reading device, a Bluetooth communication interface, an IEEE802.11-compliant communication interface.

A3. The mobile communication device of A1, further configured to signal said security alert level to one or more applications executed by said mobile computing device.

A4. The mobile communication device of A1, wherein said alert level is defined by one or more conditions selected from the group consisting of: a known Bluetooth device having been detected, a known RFID tag having been detected, a known NFC tag having been detected, a known LAN having been detected, a pre-defined geographical area having been detected, and a pre-defined movement pattern having been detected.

A5. The mobile communication device of A1, wherein said security-related action is selected from the group consisting of: erasing a browser history, erasing a browser cache, erasing browser cookies, erasing application data, erasing a contact list, erasing stored application credentials, encrypting application data, encrypting a contact list, locking said mobile communication device.

B1. A mobile communication device comprising:

a microprocessor coupled to a system bus;

a memory coupled to said system bus;

one or more sensors coupled to said system bus, said one or more sensors selected from the group consisting of: a GPS receiving device, an accelerometer, an image sensor, a radio frequency transceiver, a magnetic card reading device;

wherein said mobile communication device is configured, responsive to receiving sensor data from said one or more sensors, to select a device authentication level based on said sensor data.

B2. The mobile communication device of B1, wherein said radio frequency transceiver is provided by one of: an RFID reading device, an NFC reading device, a Bluetooth communication interface.

B3. The mobile communication device of B1, wherein said receiving sensor data comprises one of: successfully validating a data item received from said radio frequency transceiver, failing to successfully validate a data item received from said radio frequency transceiver, and failing to receive a data item from said radio frequency transceiver within a pre-defined timeout.

B4. The mobile communication device of B1, wherein said authentication level is provided by one of: requiring a user-entered password to unlock said mobile communication device, lifting a requirement of a user-entered password to unlock said mobile communication device.

C1. A mobile communication device comprising:

a microprocessor coupled to a system bus;

a memory coupled to said system bus;

a radio frequency transceiver coupled to said system bus;

wherein said mobile communication device is configured, responsive to successfully validating a data item received from said radio frequency transceiver, to unlock said mobile communication device without requiring a user-entered password; and

wherein said mobile communication device is configured, responsive to failing to successfully validate a data item received from said radio frequency transceiver, to request a user-entered password in order to unlock said mobile communication device.

C2. The mobile communication device of C1, wherein said radio frequency transceiver is provided by one of: an RFID reading device, an NFC reading device, a Bluetooth communication device.

D1. A mobile communication device comprising:

a microprocessor coupled to a system bus;

a memory coupled to said system bus;

a wireless communication interface coupled to said system bus;

a radio frequency transceiver coupled to said system bus;

wherein said mobile communication device is configured to encrypt a first data item stored in said memory using an encryption key derived from a second data item received by said radio frequency transceiver from one of: an RFID tag, an NFC tag; and

wherein said mobile communication device is further configured, responsive to receiving a request from an application executed by said mobile communication device, to decrypt said first data item yielding a decrypted data item, and to provide said decrypted data item to said application.

D2. The mobile communication device of D1, wherein said radio frequency transceiver is provided by one of: an RFID reading device, an NFC reading device, a Bluetooth communication device.

D3. The mobile communication device of D1, wherein said first data item includes one or more data items selected from the group consisting of: a user credential, an access token, a payment data item, and a postal address.

D4. The mobile communication device of D1, wherein said encryption key is derived from said second data item and at least one of: a user-provided data item, an application-specific data item.

D5. The mobile communication device of D1, wherein said encryption key is derived from said second data item and at least one of: a user-provided data item stored in said memory, an application-specific data item stored in said memory; and

wherein said mobile communication device is further configured to erase from said memory said user-provided data item responsive to receiving one of: a user interface command, a pre-defined message via said wireless communication interface.

E1. A mobile communication device comprising:

a microprocessor coupled to a system bus;

a memory coupled to said system bus;

a wireless communication interface coupled to said system bus;

a radio frequency transceiver coupled to said system bus;

wherein said mobile communication device is configured to poll radio frequency targets using said radio frequency transceiver; and

wherein said mobile communication device is further configured, responsive to successfully validating a data item received from said radio frequency transceiver, to perform one of: unlocking said mobile communication device, unlocking an application executed by said mobile communication device, and unlocking a function of an application executed by said mobile communication device.

E2. The mobile communication device of E1, wherein said radio frequency transceiver is provided by one of: an RFID reading device, an NFC reading device, a Bluetooth communication device.

E3. The mobile communication device of E1, wherein said validating is performed by calculating a pre-defined hash function of said data item.

E4. The mobile communication device of E1, wherein said validating is performed by comparing said data item to a value stored in said memory.

E5. The mobile communication device of E1, wherein said mobile communication device is further configured, responsive to expiration of a pre-defined timeout, to lock one of: said mobile communication device, an application executed by said mobile communication device, and a function of an application executed by said mobile communication device.

F1. A mobile communication device comprising:

a microprocessor coupled to a system bus;

a memory coupled to said system bus;

one or more sensors coupled to said system bus, said one or more sensors selected from the group consisting of: a GPS receiving device, an accelerometer, an image sensor, a radio frequency transceiver, a magnetic card reading device;

wherein said mobile communication device is configured to validate a sensor data pattern, responsive to receiving sensor data from said one or more sensors, said one or more sensors including said radio frequency transceiver; and

wherein said mobile communication device is further configured, responsive to successfully validating a sensor data pattern, to perform at least one action corresponding to said sensor data pattern.

F2. The mobile communication device of F1, wherein said radio frequency transceiver is provided by one of: an RFID reading device, an NFC reading device, a Bluetooth communication device.

F3. The mobile communication device of F1, wherein said sensor data received from said one or more sensors comprises two or more sensor data items received from two or more sensors.

F4. The mobile communication device of F1, wherein said sensor data received from said one or more sensors comprises two or more sensor data items received from said radio frequency transceiver.

F5. The mobile communication device of F1, wherein said at least one action is selected from the group consisting of: launching an application, performing an application function, and passing a parameter to an application, said parameter derived from said sensor data.

While the present invention has been described with reference to a number of specific embodiments, it will be understood that the true scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than the mentioned certain number of elements.

1. A mobile communication device comprising:
a microprocessor coupled to a system bus;
a memory coupled to said system bus;
one or more sensors coupled to said system bus, said one or more sensors selected from the group consisting of: a GPS receiving device, an accelerometer, an image sensor, a radio frequency transceiver, a magnetic card reading device;
wherein said mobile communication device is configured, responsive to receiving sensor data from said one or more sensors, to select a security alert level based on said sensor data; and
wherein said mobile communication device is further configured to perform at least one security-related action corresponding to said security alert level.

2. The mobile communication device of claim 1, wherein said radio frequency transceiver is provided by one of: an RFID reading device, an NFC reading device, a Bluetooth communication interface, an IEEE802.11-compliant communication interface.

3. The mobile communication device of claim 1, further configured to signal said security alert level to one or more applications executed by said mobile computing device.

4. The mobile communication device of claim 1, wherein said alert level is defined by one or more conditions selected from the group consisting of: a known Bluetooth device having been detected, a known RFID tag having been detected, a known NFC tag having been detected, a known LAN having been detected, a pre-defined geographical area having been detected, and a pre-defined movement pattern having been detected.

5. The mobile communication device of claim 1, wherein said security-related action is selected from the group consisting of: erasing a browser history, erasing a browser cache, erasing browser cookies, erasing application data, erasing a contact list, erasing stored application credentials, encrypting application data, encrypting a contact list, locking said mobile communication device.

6. A mobile communication device comprising:
a microprocessor coupled to a system bus;
a memory coupled to said system bus;
one or more sensors coupled to said system bus, said one or more sensors selected from the group consisting of: a GPS receiving device, an accelerometer, an image sensor, a radio frequency transceiver, a magnetic card reading device;
wherein said mobile communication device is configured, responsive to receiving sensor data from said one or more sensors, to select a device authentication level based on said sensor data.

7. The mobile communication device of claim 6, wherein said radio frequency transceiver is provided by one of: an RFID reading device, an NFC reading device, a Bluetooth communication interface.

8. The mobile communication device of claim 6, wherein said receiving sensor data comprises one of: successfully validating a data item received from said radio frequency transceiver, failing to successfully validate a data item received from said radio frequency transceiver, and failing to receive a data item from said radio frequency transceiver within a pre-defined timeout.

9. The mobile communication device of claim 6, wherein said authentication level is provided by one of: requiring a user-entered password to unlock said mobile communication device, lifting a requirement of a user-entered password to unlock said mobile communication device.

10. A mobile communication device comprising:
a microprocessor coupled to a system bus;
a memory coupled to said system bus;
a radio frequency transceiver coupled to said system bus;
wherein said mobile communication device is configured, responsive to successfully validating a data item received from said radio frequency transceiver, to unlock said mobile communication device without requiring a user-entered password; and
wherein said mobile communication device is configured, responsive to failing to successfully validate a data item received from said radio frequency transceiver, to request a user-entered password in order to unlock said mobile communication device.

11. The mobile communication device of claim 10, wherein said radio frequency transceiver is provided by one of: an RFID reading device, an NFC reading device, a Bluetooth communication device.

12. A mobile communication device comprising:
a microprocessor coupled to a system bus;
a memory coupled to said system bus;
a wireless communication interface coupled to said system bus;
a radio frequency transceiver coupled to said system bus;
wherein said mobile communication device is configured to encrypt a first data item stored in said memory using an encryption key derived from a second data item received by said radio frequency transceiver from one of: an RFID tag, an NFC target, a Bluetooth device; and
wherein said mobile communication device is further configured, responsive to receiving a request from an application executed by said mobile communication device, to decrypt said first data item yielding a decrypted data item, and to provide said decrypted data item to said application.

13. The mobile communication device of claim 12, wherein said radio frequency transceiver is provided by one of: an RFID reading device, an NFC reading device, a Bluetooth communication device.

14. The mobile communication device of claim 12, wherein said first data item includes one or more data items selected from the group consisting of: a user credential, an access token, a payment data item, and a postal address.

15. The mobile communication device of claim 12, wherein said encryption key is derived from said second data item and at least one of: a user-provided data item, an application-specific data item.

16. The mobile communication device of claim 12, wherein said encryption key is derived from said second data item and at least one of: a user-provided data item stored in said memory, an application-specific data item stored in said memory; and
wherein said mobile communication device is further configured to erase from said memory said user-provided data item responsive to receiving one of: a user interface command, a pre-defined message via said wireless communication interface.

17. A mobile communication device comprising:
a microprocessor coupled to a system bus;
a memory coupled to said system bus;
a wireless communication interface coupled to said system bus;
a radio frequency transceiver coupled to said system bus;
wherein said mobile communication device is configured to poll radio frequency targets using said radio frequency transceiver; and
wherein said mobile communication device is further configured, responsive to successfully validating a data item received from said radio frequency transceiver, to perform one of: unlocking said mobile communication device, unlocking an application executed by said mobile communication device, and unlocking a function of an application executed by said mobile communication device.

18. The mobile communication device of claim 17, wherein said radio frequency transceiver is provided by one of: an RFID reading device, an NFC reading device, a Bluetooth communication device.

19. The mobile communication device of claim 17, wherein said validating is performed by calculating a pre-defined hash function of said data item.

20. The mobile communication device of claim 17, wherein said validating is performed by comparing said data item to a value stored in said memory.

21. The mobile communication device of claim 17, wherein said mobile communication device is further configured, responsive to expiration of a pre-defined timeout, to lock one of: said mobile communication device, an application executed by said mobile communication device, and a function of an application executed by said mobile communication device.

22. A mobile communication device comprising:
a microprocessor coupled to a system bus;
a memory coupled to said system bus;
one or more sensors coupled to said system bus, said one or more sensors selected from the group consisting of: a GPS receiving device, an accelerometer, an image sensor, a radio frequency transceiver, a magnetic card reading device;
wherein said mobile communication device is configured to validate a sensor data pattern, responsive to receiving sensor data from said one or more sensors, said one or more sensors including said radio frequency transceiver; and
wherein said mobile communication device is further configured, responsive to successfully validating a sensor data pattern, to perform at least one action corresponding to said sensor data pattern.

23. The mobile communication device of claim 22, wherein said radio frequency transceiver is provided by one of: an RFID reading device, an NFC reading device, a Bluetooth communication device.

24. The mobile communication device of claim 22, wherein said sensor data received from said one or more sensors comprises two or more sensor data items received from two or more sensors.

25. The mobile communication device of claim 22, wherein said sensor data received from said one or more sensors comprises two or more sensor data items received from said radio frequency transceiver.

26. The mobile communication device of claim 22, wherein said at least one action is selected from the group consisting of: launching an application, performing an application function, and passing a parameter to an application, said parameter derived from said sensor data.
